(19) United States
(12) Patent Application Publication
(10) Pub. No.: US 2024/0336180 A1
(43) Pub. Date: Oct. 10, 2024

(54) Actuator

(71) Applicant: Dare Auto Inc., Plymouth, MI (US)

(72) Inventors: John Andrew Bleecker, III, Canton, MI (US); Andrew James Kalina, Troy, MI (US)

(21) Appl. No.: 18/296,836

(22) Filed: Apr. 6, 2023

(51) Int. Cl. B60N 2/829; B60N 2/824

(52) U.S. Cl. CPC B60N 2/829; B60N 2/824

(57) ABSTRACT

An actuator may include a shaft with a first end and a second end. The shaft may include a disengagement portion near the first end and an engagement portion near the second end. The actuator may also include a motor coupled to the first end of the shaft and configured to rotate the shaft about a longitudinal axis of the shaft. A housing may be coupled to the shaft and may be configured to move toward the disengagement portion during rotation of the shaft in a first direction. The housing may have a coupled position, in which the housing is engaged with the engagement portion of the shaft, and an uncoupled position, in which the housing is disengaged from the engagement portion of the shaft and is located adjacent to the disengagement portion of the shaft.

### TECHNICAL FIELD

This disclosure relates to an actuator.

### BACKGROUND

An actuator is a component of a system that may cause physical motion of the system by converting energy (e.g., electrical energy) into movement. A lead screw actuator is a type of actuator that converts rotational motion to linear motion. A lead screw actuator may include a threaded rod coupled to a motor configured to rotate the threaded rod. A nut may be engaged with the rod and may be configured to move linearly relative to the rod as the rod rotates.

### SUMMARY

One aspect of the disclosure is an actuator. The actuator may include a shaft with a first end and a second end. The shaft may include a disengagement portion near the first end and an engagement portion near the second end. The actuator may also include a motor coupled to the first end of the shaft and configured to rotate the shaft about a longitudinal axis of the shaft. A housing may be coupled to the shaft and may be configured to move toward the disengagement portion during rotation of the shaft in a first direction. The housing may have a coupled position, in which the housing is engaged with the engagement portion of the shaft, and an uncoupled position, in which the housing is disengaged from the engagement portion of the shaft and is located adjacent to the disengagement portion of the shaft. Movement of the housing toward the motor is limited in the uncoupled position such that, during rotation of the shaft in a second direction that is opposite the first direction, the housing is configured to engage with the engagement portion of the shaft.

Another aspect of the disclosure is an actuator that has a shaft including a first end and a second end. The shaft includes a disengagement portion near the first end and an engagement portion near the second end. A motor is coupled to the first end of the shaft and is configured to rotate the shaft about a longitudinal axis of the shaft. A housing is coupled to the shaft and is configured to move toward the disengagement portion during rotation of the shaft in a first direction. The housing has a coupled position, in which the housing is engaged with the engagement portion of the shaft, and an uncoupled position, in which the housing is disengaged from the engagement portion of the shaft and is located adjacent to the disengagement portion of the shaft. A biasing portion is slidably engaged with the shaft and is positioned between the housing and the motor, and the biasing portion is configured to limit movement of the housing toward the motor with the housing in the uncoupled position during rotation of the shaft in the first direction.

Yet another aspect of the disclosure is a vehicle that includes a seat and a head support. The head support includes a base removably coupled to the seat, a headrest movably coupled to the base, and an actuator configured to move the headrest relative to the base. The actuator has an end stop that limits motion of the headrest relative to the base when the headrest reaches an end stop position, and the actuator is configured to limit binding of the headrest to allow the headrest to move from the end stop position.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an illustration of a seat.

FIG. 2 is an illustration of a head support of the seat of FIG. 1.

FIG. 3 is an exploded view of an actuator.

FIG. 4 is an assembled view of the actuator of FIG. 3 in a coupled position.

FIG. 5 is an assembled view of the actuator of FIG. 3 in an uncoupled position.

FIGS. 6A-C are illustrations of a biasing portion of the actuator of FIG. 3.

FIG. 7 is an illustration of a biasing portion of the actuator of FIG. 3.

### DETAILED DESCRIPTION

A lead screw actuator may include a threaded rod and a nut engaged with the threaded rod. The nut may be configured to move linearly relative to the threaded rod as the rod is rotated by, for example, an electric motor. The threaded rod may be coupled to other structures at one or more ends of the threaded rod. For example, the threaded rod may be coupled with the electric motor at one end and a bearing at the opposite end. In some instances, the nut engaged with the threaded rod may contact one of the other structures. As the motor continues to rotate, the nut may become lodged against the other structure, and the motor may be unable to dislodge the nut by rotating in the opposite direction. Thus, the actuator may become stuck and may require maintenance for it to function.

Implementations disclosed herein relate to a system to limit instances in which an actuator may become stuck. For example, a lead screw actuator may include a rod with a threaded portion and an unthreaded portion. As the nut approaches a structure during rotation of the threaded rod in a first direction, the nut may disengage from the threaded portion as the nut reaches the unthreaded portion. The nut may contact a biasing portion located between the nut and the structure when the nut is disengaged from the threaded portion. The biasing portion may be configured to maintain a position of the nut adjacent to the threaded portion. Thus, during rotation of the threaded rod in a second direction that is opposite the first direction, the nut is configured to engage with the threaded portion of the threaded rod.

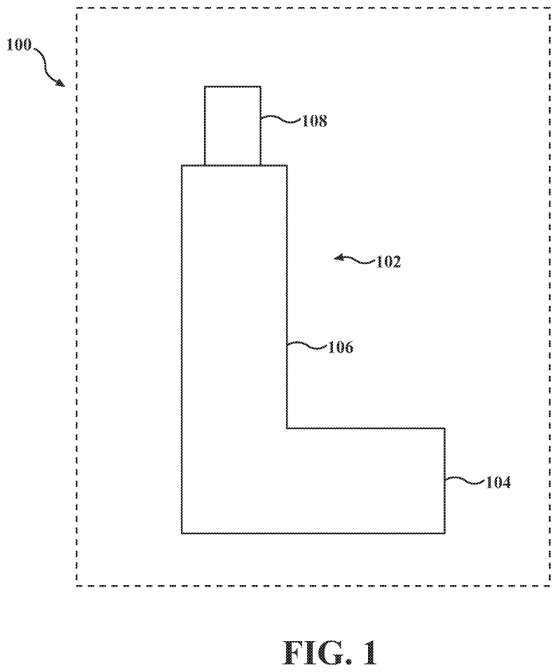

FIG. 1 is an illustration of a seat 102 within a cabin of a vehicle 100. The vehicle 100 may be any type of vehicle. For example, the vehicle 100 may include gas or diesel-powered vehicle, electric vehicles, marine vehicles (e.g., boats, submarines, etc.), aircraft (e.g., airplanes, helicopters, etc.), or a combination thereof.

The seat 102 may be configured to secure an occupant. In some implementations, the occupant may be a passenger in the vehicle 100. The occupant may also be in control of the vehicle 100 (e.g., a driver). In some implementations, the seat 102 may include a base 104 and a back 106. Each of the base 104 and the back 106 may be adjustable relative to each other. For example, base 104 may be coupled to an actuator configured to move the base 104 in various directions. The back 106 may also be coupled to an actuator configured to move the back 106 in various directions.

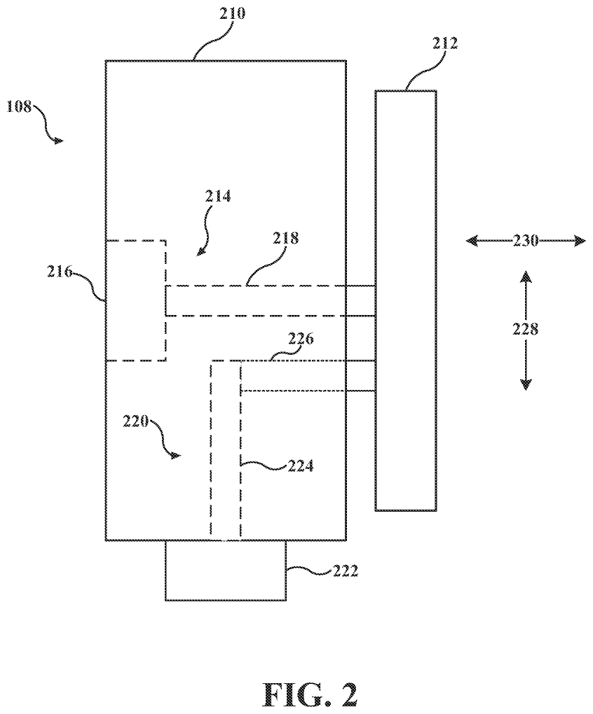

The seat 102 may also include a head support 108 configured to be positioned behind the head of the occupant. The head support 108 may be configured to move relative to the back 106. For example, the head support 108 may be configured to move in an extension direction relative to the back 106. More specifically, the head support 108 may be configured to move either toward or away from the back 106 (e.g., in a generally vertical direction relative to the back 106). The head support 108 is further described with reference to FIG. 2.

FIG. 2 is an illustration of the head support 108 of the seat 102 of FIG. 1. The head support 108 is shown to include a base 210. The base 210 is configured to be removably coupled to the seat 102. More specifically, the base 210 is configured to move either toward or away from the back 106. In some implementations, the base 210 may include posts extending toward and interfacing with the back 106 to secure the base 210 to the back 106. The back 106 may include a release mechanism configured to permit removal of the base 210 from the back 106. For example, the back 106 may include a button that, when retained in a depressed position, may allow the posts to be removed from the back 106.

The head support 108 may also include a headrest 212 that is movably coupled to the base 210. For example, the headrest 212 may be configured to move in at least two directions relative to the base 210. More specifically, the headrest 212 may be configured to move in an extension direction 228 relative to the headrest 212 and the back 106. The headrest 212 may also be configured to move in a lateral direction 230 relative to the base 210 (e.g., aft or fore, or toward or away from the base 210, respectively).

In some implementations, the headrest 212 is coupled to an actuator 214. The actuator 214 may be configured to move the headrest 212 in the lateral direction 230 relative to the base 210. In some implementations, the actuator 214 may be a lead screw actuator. The actuator 214 may include a motor 216. The motor 216 may be for example, an electric rotary motor. The motor 216 may be coupled to a shaft 218 that is configured to rotate as the motor 216 rotates. In some implementations, the shaft 218 is oriented approximately parallel with the lateral direction 230 (e.g., within two degrees of being perfectly parallel). During rotation of the motor 216 in a first direction, the headrest 212 may be configured to move in an outward lateral direction relative to the base 210 (e.g., away from the base 210). During rotation of the motor 216 in a second direction that is opposite the first direction, the headrest 212 may be configured to move in an inward lateral direction relative to the base 210 (e.g., toward the base 210).

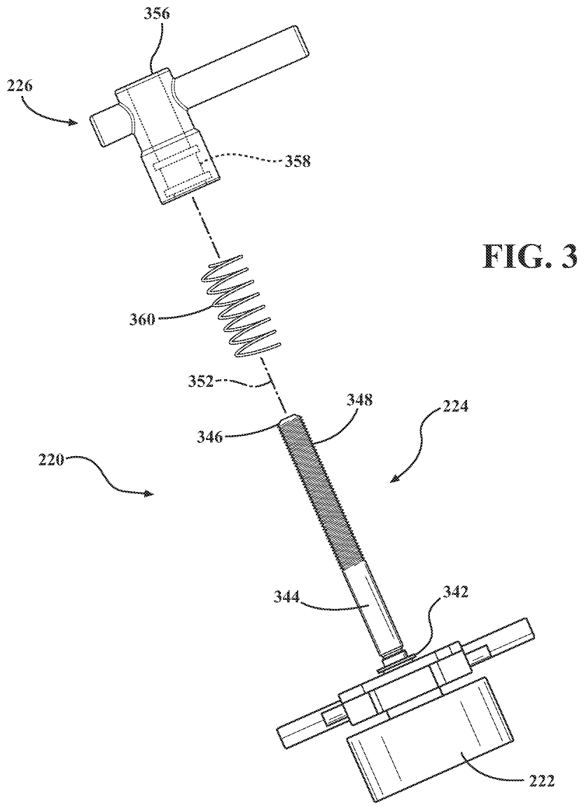

The headrest 212 may also be coupled to an actuator 220. The actuator 220 may be configured to move the headrest 212 in the extension direction 228 relative to the base 210. In some implementations, the actuator 220 may be a lead screw actuator. The actuator 220 may include a motor 222, which may be, for example, an electric rotary motor. The motor 222 may be coupled to a shaft 224 that is configured to rotate as the motor 222 rotates. In some implementations, the shaft 224 may be oriented approximately parallel with the extension direction 228 (e.g., within two degrees of being perfectly parallel). The shaft 224 may also be coupled to a housing 226 that extends between and is coupled to the shaft 224 and the headrest 212. The housing 226 may be configured to move in the extension direction 228 relative to the shaft 224 as the shaft 224 rotates, thereby causing the headrest 212 to move in the extension direction 228. During rotation of the motor 222 in a first direction, the headrest 212 may be configured to move in the extension direction 228 toward the back 106. During rotation of the motor 222 in a second direction that is opposite the first direction, the headrest 212 may be configured to move in the extension direction 228 away from the back 106. The actuator 220 is further described with reference to FIGS. 3-5.

Though motion of the headrest 212 is described as being controlled by the actuator 214 and the actuator 220, the motion of the headrest 212 (e.g., in the extension direction 228 and the lateral direction 230) may be controlled by a single actuator. For example, the operations of the actuator 214 and the actuator 220 may be combined into one actuator that may be configured to move the headrest 212 in the extension direction 228 and the lateral direction 230.

FIG. 3 is an exploded view of the actuator 220. Though the actuator 220 is shown and described below, one should understand that the description of the actuator 220 may also apply to the actuator 214. Accordingly, the actuator 214 may include similar components and operate in a similar manner as the actuator 220.

The actuator 220 is shown to include the motor 222, the shaft 224, and the housing 226. The motor 222 may be an electrical rotary motor with a rotor that is configured to rotate in response to an electrical signal. For example, the motor 222 may be electrically coupled with a switch in the cabin of the vehicle 100. Moving the switch in a first direction may cause the motor 222 to rotate in a first direction. Moving the switch in a second direction may cause the motor 222 to rotate in a second direction that is opposite the first direction. In some implementations, the switch may be moved by an occupant of the vehicle 100 (e.g., the occupant of the vehicle 100 may desire to adjust the position of the headrest 212 for comfort). The motor 222 may be configured to rotate about a longitudinal axis 352.

The shaft 224 may be a generally cylindrical structure that is coupled to the motor 222. More specifically, the shaft 224 may be coupled to a rotor of the motor 222. Thus, the shaft 224 may be positioned concentrically with the motor 222 such that shaft 224 is aligned with the longitudinal axis 352 and is configured to rotate about the longitudinal axis 352.

The shaft 224 may be formed from metals, plastics, ceramics, or a combination thereof. For example, the shaft 224 may be formed from steel, stainless steel, aluminum, titanium, or a combination thereof. The shaft 224 may also be formed from zirconia, silicon nitride, or other ceramics. Additionally, the shaft 224 may be formed from plastics such as acetal, nylon, polycarbonate, polypropylene, or a combination thereof.

The shaft 224 may have a first end 342 that is coupled to the motor 222. For example, the first end 342 may be coupled with the rotor of the motor 222. Thus, the motor 222 may be configured to rotate the shaft 224 about the longitudinal axis 352. In some implementations, the longitudinal axis 352 may be collinear with a longitudinal axis of the shaft 224. Accordingly, the motor 222 may be configured to rotate the shaft 224 about the longitudinal axis of the shaft 224.

The shaft 224 may also include a second end 346 located opposite the first end. In some implementations, the second end 346 may be free (e.g., the second end 346 may not be coupled to another component). The second end 346 may also be coupled with a support component. For example, the second end 346 may be rotatably coupled with a bearing that limits lateral motion of the shaft 224 relative to the longitudinal axis 352 and permits rotation of the shaft 224 about the longitudinal axis 352.

The shaft 224 may also include a disengagement portion 344 located near the first end 342. In some implementations, the disengagement portion 344 is coupled to the first end 342. The disengagement portion 344 may also be located adjacent to the first end 342. The disengagement portion 344 may be configured to limit coupling between the disengagement portion 344 and other components. For example, the disengagement portion 344 may have an outer surface that is generally smooth (e.g., the disengagement portion 344 may be unthreaded and may be free from any protrusions, recesses, openings, holes, etc.) to limit the ability of other components to couple to the disengagement portion 344.

The shaft 224 may also include an engagement portion 348 located near the second end 346. In some implementations, the engagement portion 348 is coupled to the second end 346. The engagement portion 348 may also be located adjacent to the second end 346. The engagement portion 348 may be configured to couple with other components. For example, the engagement portion 348 may have threads configured to engage with corresponding threads of other components. The engagement portion 348 may also define protrusions, recesses, openings, slots, etc., that may be configured to engage with corresponding portions of other components.

The housing 226 may include a body 356. The body 356 may be configured to interface with the shaft 224 and with the headrest 212. Thus, the body 356 may be configured to transmit motion of the shaft 224 to the headrest 212, thereby moving the headrest 212 in the extension direction 228. For example, the body 356 may have a threaded portion configured to engage the engagement portion 348 of the shaft 224. The body 356 may also be constrained in a rotational direction such that rotational motion of the shaft 224 is converted to linear motion of the body 356 (e.g., linear motion along the longitudinal axis 352). For example, the interface between the housing 226 and the headrest 212 may limit rotation of the body 356 (and thus, the housing 226), thereby allowing the body 356 to move along the longitudinal axis 352 to move the headrest 212 in the extension direction 228.

In some implementations, the housing 226 may also include a nut 358 coupled to the body 356. The nut 358 may include a threaded portion configured to interface with the engagement portion 348 of the shaft 224. The body 356 may also be configured to limit rotational motion between the nut 358 and the body 356 such that rotational motion of the shaft 224 is converted to linear motion of the body 356. For example, the body 356 may be rigidly coupled to the nut 358. The body 356 and the nut 358 may also be a unitary component.

The actuator 220 may also include a biasing portion 360. In some implementations, the biasing portion 360 is configured to elastically deform when a load is applied to the biasing portion 360, and then return to its original configuration when the load is removed from the biasing portion 360. The biasing portion 360 may be slidably engaged with the shaft 224 and may be positioned between the housing 226 and the motor 222. In some implementations, the biasing portion 360 may be free to slide between the shaft 224 and the motor 222. Thus, the biasing portion 360 may be configured for contact with the shaft 224 and with the motor 222. In some implementations, the biasing portion 360 may be coupled to the housing 226. For example, the biasing portion 360 may be coupled to the body 356 and located at an end of the body 356 closest to the motor 222. The biasing portion 360 may also be coupled to the motor 222 near or adjacent to the first end 342. For example, the biasing portion 360 may be coupled to a stator of the motor 222 such that the position of the biasing portion may be fixed relative to the housing 226.

The biasing portion 360 may be any type of system or device configured to function as described. For example, the biasing portion 360 may be a coil spring. The biasing portion 360 may also be a disc spring. Thus, the biasing portion 360 may be formed from a metal such as steel (e.g., stainless steel, alloy steel, high carbon steel, spring steel, etc.). The biasing portion 360 may also be formed from non-ferrous alloys such as titanium, bronze, copper, etc. In some implementations the biasing portion 360 may be a gasket formed from a resilient material. In such implementations, the biasing portion 360 may be formed from rubber (e.g., neoprene, nitrile, silicone, etc.), cork, synthetic fibers, etc.

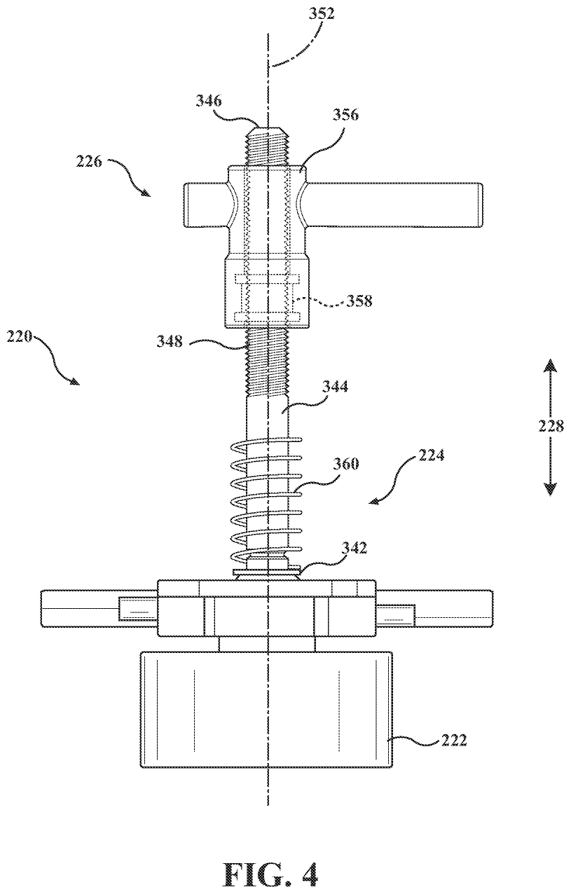

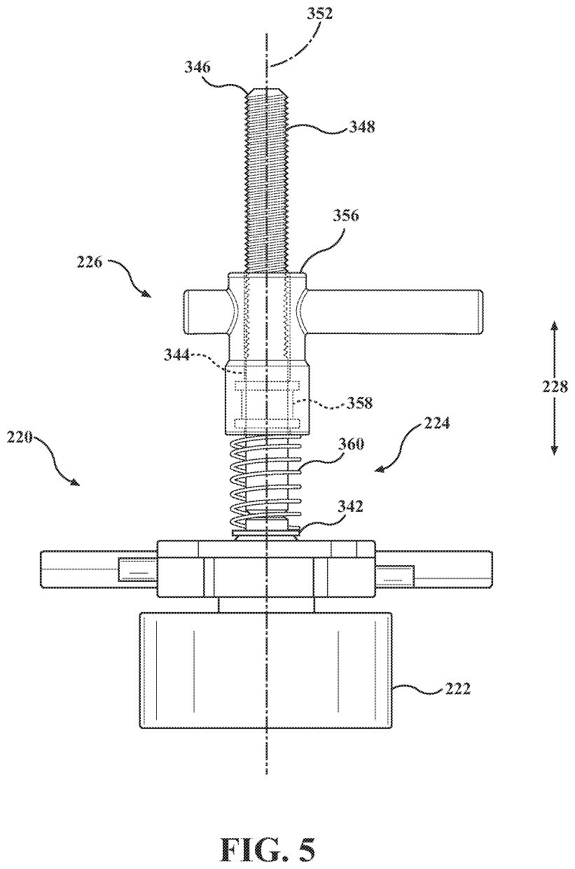

FIG. 4 is an assembled view of the actuator 220 of FIG. 3 in a coupled position. FIG. 5 is an assembled view of the actuator 220 of FIG. 3 in an uncoupled position. As shown, the housing 226 may be coupled to the shaft 224 and has a coupled position and an uncoupled position. In the coupled position, the housing 226 may be engaged with the engagement portion 348 of the shaft 224. For example, the threaded portion of the body 356 may be engaged with the engagement portion 348. In some implementations, the threaded portion of the nut 358 may be engaged with the engagement portion 348. In the uncoupled position, the housing 226 is disengaged from the engagement portion 348 of the shaft 224 and is located adjacent to the disengagement portion 344 of the shaft 224. Thus, the housing 226 is slidably coupled to the disengagement portion 344 of the shaft 224 when in the uncoupled position.

The motor 222 is configured to rotate in a first direction (e.g., clockwise) and a second direction (e.g., counterclockwise) that is opposite the first direction. In some implementations, the housing 226 is configured to move in the extension direction 228 during rotation of the motor 222 (and thus, the shaft 224) in the first direction and the second direction. For example, the housing 226 may be configured to move toward the disengagement portion 344 during rotation of the shaft 224 in the first direction with the housing 226 in the coupled position. The housing 226 may also be configured to move away from the disengagement portion 344 during rotation of the shaft 224 in the second direction with the housing 226 in the coupled position.

During rotation of the shaft 224 in the first direction with the housing 226 in the coupled position, the housing 226 moves toward the disengagement portion 344 (e.g., as shown in FIG. 4). Such movement corresponds to movement of the headrest 212 in the extension direction 228 toward the back 106. When the threaded portion of the housing 226 reaches the disengagement portion 344 (e.g., such that the housing 226 is in the uncoupled position), the threaded portion of the housing 226 disengages from the engagement portion 348. Disengagement of the threaded portion of the housing 226 from the engagement portion 348 allows the housing 226 to slide freely along the disengagement portion 344.

In the uncoupled position, movement of the housing 226 toward the motor 222 is limited. For example, during rotation of the shaft 224 in the first direction with the housing 226 in the uncoupled position, the engagement portion 348 may not engage with the threaded portion of the housing 226. More specifically, the engagement portion 348 may contact the threaded portion of the housing 226 but, because the shaft 224 is rotating in the first direction, such contact does not result in engagement between the engagement portion 348 and the threaded portion of the housing 226. Accordingly, the threaded portion of the housing 226 is configured to remain disengaged from the threads of the engagement portion 348 during rotation of the shaft 224 in the first direction with the housing 226 in the uncoupled position. In addition, contact between the engagement portion 348 and the threaded portion of the housing 226 may not result in movement of the housing 226 toward the motor 222. Thus, the housing 226 may remain generally stationary when in the uncoupled position during rotation of the shaft 224 in the first direction.

In some implementations, the housing 226 is configured to resist a force imparted to the housing 226 by the shaft 224 during rotation of the shaft 224 in the first direction when the housing 226 is in the uncoupled position. For example, contact between the engagement portion 348 and the threaded portion of the housing 226 may impart a force to the housing 226 in the extension direction 228 toward the motor 222. The force may cause the housing 226 to contact the biasing portion 360, and the biasing portion 360 may impart a force to the housing 226 that is opposite to the force imparted to the housing 226 by the engagement portion 348. More specifically, the biasing portion 360 may be compressed between the housing 226 and the motor 222 with the housing 226 in the uncoupled position. Thus, the biasing portion 360 may be configured to limit movement of the housing 226 toward the motor 222 with the housing 226 in the uncoupled position during rotation of the shaft 224 in the first direction. Furthermore, the biasing portion 360 may be configured to resist movement of the housing 226 toward the motor 222 when the housing 226 is in the uncoupled position and the biasing portion 360 is in contact with the motor 222. Because movement of the housing 226 in the extension direction 228 toward the motor 222 is limited when the housing 226 is in the uncoupled position, the uncoupled position of the housing 226 may also be referred to as an end stop position (e.g., a position from which the housing 226 can no longer move further toward the motor 222).

Arranged as described, binding of the housing 226 against the motor 222 may be limited when the housing 226 is in the uncoupled position during rotation of the shaft 224 in the first direction. For example, the biasing portion 360 may be positioned between the housing 226 and the motor 222 and may limit motion of the housing 226 toward the motor 222, as described. By limiting motion of the housing 226 toward the motor 222, the biasing portion 360 is configured to limit contact between the housing 226 and the motor 222, thereby limiting binding of the housing 226 against the motor 222.

The biasing portion 360 may also be configured to maintain contact between the threaded portion of the housing 226 and the engagement portion 348. For example, the biasing portion 360 may impart a force to the housing 226 in the direction of the engagement portion 348 such that, during rotation of the shaft 224 in the first direction, the engagement portion 348 may contact the threaded portion of the housing 226.

Maintaining contact between the threaded portion of the housing 226 and the engagement portion 348 may allow the housing 226 to re-engage with the engagement portion 348. For example, during rotation of the shaft 224 in the second direction (e.g., opposite the first direction), the threaded portion of the housing 226 may be configured to engage with the engagement portion 348. More specifically, during rotation of the shaft 224 in the second direction, the threaded portion of the housing 226 is configured to engage the threads of the engagement portion 348 (e.g., based on contact between the threaded portion of the housing 226 and the engagement portion 348 with the housing 226 in the uncoupled position) to move the housing 226 from the uncoupled position to the coupled position. Further rotation of the shaft 224 in the second direction is configured to move the housing 226 in the extension direction 228 away from the body 106.

Returning to FIGS. 1-2, the actuator 214 and the actuator 220 may have end stops (e.g., similar to the uncoupled position of the housing 226) that may limit motion of the headrest 212 relative to the base 210 when the headrest 212 reaches an end stop position. For example, the headrest 212 may have first and second end stop positions in the extension direction 228. The first end stop position may be closer to the body 106 and the second end stop position may be further from the body 106. The first end stop position may correspond to a first end stop of the actuator 220 and the second end stop position may correspond to a second end stop of the actuator 220. For example, the first end stop may correspond to the disengagement portion 344 of the shaft 224, and the second end stop may correspond to a similar portion of the shaft 224 located near the second end 346 of the shaft 224 (not shown). In addition, the headrest 212 may have third and fourth end stop positions in the lateral direction 230. The third end stop position may be closer to the base 210 in the lateral direction 230 and the fourth end stop position may be further from the base 210 in the lateral direction 230. Thus, the actuator 214 and the actuator 220 may be configured to limit binding of the headrest 212 to allow the headrest 212 to move from any of the end stop positions.

Furthermore, the housing 226 may be configured to limit movement of the headrest 212 (e.g., in the extension direction 228 toward the body 106) during rotation of the shaft 224 in the first direction. More specifically, the biasing portion 360 may be configured to limit movement of the headrest 212 toward the back 106 during rotation of the shaft 224 in the first direction. As such, during rotation of the shaft 224 in the second direction, the housing 226 may be configured to allow movement of the headrest 212 in the extension direction 228 away from the body 106. For example, during rotation of the shaft 224 in the second direction, the housing 226 may be configured to engage with the engagement portion 348 of the shaft 224 to move from the uncoupled position to the coupled position.

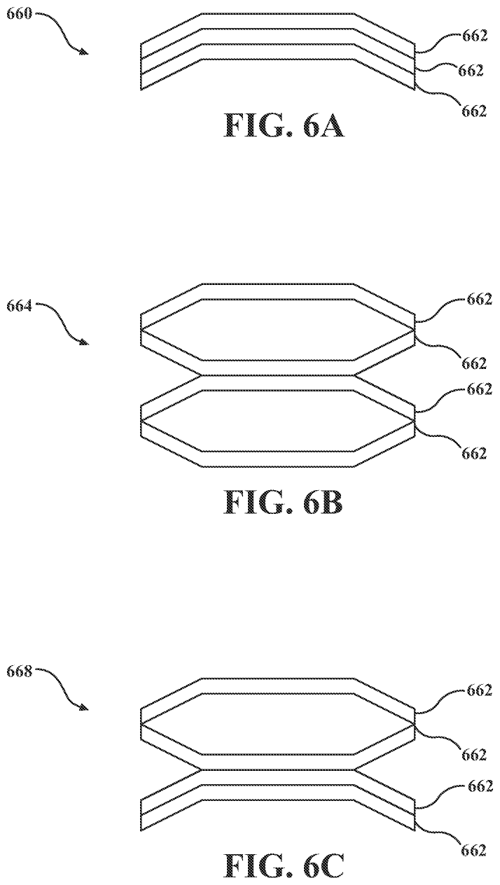

FIGS. 6A-C are illustrations of a biasing portion 662 of the actuator 220 of FIG. 3. The biasing portion 662 may be a disc spring. FIG. 6A show an illustration of a nested arrangement 660 of the biasing portion 662. FIG. 6B shows an illustration of a stacked arrangement 664 of the biasing portion 662. FIG. 6C shows an illustration of a nested and stacked arrangement 668 of the biasing portion 662.

In some implementations, the biasing portion 662 may be positioned similarly to the biasing portion 360. For example, the biasing portion 662 may be coupled to an end of the housing 226 closest to the motor 222. The biasing portion 662 may also be slidably coupled to the shaft 224 and positioned between the housing 226 and the motor 222.

Based on the size of the housing 226 and the disengagement portion 344 and the force required, the various arrangements of the biasing portion 662 may be implemented. For example, the nested arrangement 660 provides a force equivalent to the total number of biasing portions 662 used while having a deflection equivalent to one biasing portion 662. Thus, the nested arrangement 660 may be implemented in instances where a larger force is needed while maintaining the deflection.

The stacked arrangement 664 provides a force equivalent to one biasing portion 662 while having a deflection equivalent to the total number of biasing portions 662 used. Thus, the stacked arrangement 664 may be implemented in instances where a larger deflection is needed while maintaining the force of a single biasing portion 662.

The nested and stacked arrangement 668 provides both a larger force and a larger deflection based on the number of biasing portions 662 used in each portion of the arrangement.

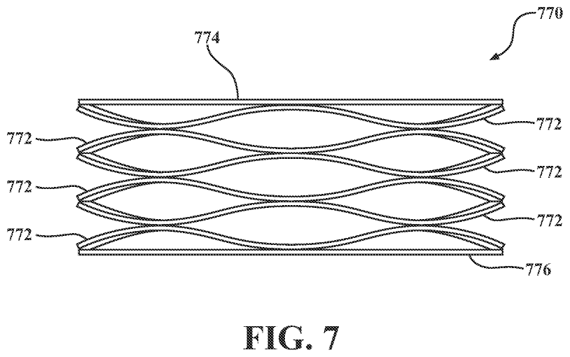

FIG. 7 is an illustration of a biasing portion 770 of the actuator 220 of FIG. 3. In some implementations, the biasing portion 770 may be a wave spring. For example, the biasing portion 770 may include multiple coils 772, where each of the coils 772 has an undulating shape that facilitates contact between adjacent coils 772. For example, valleys of one of the coils 772 may be configured to contact corresponding peaks of the coil 772 positioned directly below. Arranged as described, the biasing portion 770 may be configured to provide the same or similar function as a coil spring (e.g., the biasing portion 360) and may require less space than a coil spring. In some implementations, the biasing portion 770 may include a first end plate 774 located at a first end of the biasing portion 770 and a second end plate 776 located at a second end of the biasing portion 770. The first end plate 774 and the second end plate 776 may provide a generally flat surface for the biasing portion 770 to engage the motor 222 and the housing 226. In some implementations, the first end plate 774 and the second end plate 776 may be omitted.

In operation, an occupant may desire to move the headrest 212 for comfort. Using an interface such as a switch or a button, the occupant may move the headrest 212 in one or more of the extension direction 228 or the lateral direction 230. As an example, the occupant may move the headrest 212 in the extension direction 228 toward the body 106 of the seat 102. As the headrest 212 moves toward the body 106, the housing 226 moves along the engagement portion 348 while the housing 226 is in the coupled position (e.g., the shaft 224 is rotating in the first direction). When the housing 226 reaches the first end stop position (e.g., the housing 226 moves from the coupled position to the uncoupled position), the headrest 212 may stop moving in the extension direction 228 toward the body 106 even as the shaft 224 continues to rotate in the first direction. Even if the occupant attempts to manually move the motor 222 and/or the shaft 224 to move the headrest 212 even further toward the body 106, the headrest 212 will remain at the end stop position and will be limited from binding.

A different occupant may desire to move the headrest 212 in the extension direction 228 away from the body 106 for comfort. Using the interface, the different occupant may attempt to move the headrest 212 in the desired direction (e.g., by the shaft 224 rotating in the second direction). Because the biasing portion 360 (or the biasing portion 662, the biasing portion 770, etc.) is configured to maintain the threaded portion of the housing 226 adjacent to (e.g., in contact with) the engagement portion 348 of the shaft 224, the engagement portion 348 is configured to re-engage with the threaded portion of the housing 226 when the shaft 224 rotates in the second direction (e.g., the housing 226 moves from the uncoupled position to the coupled position). Thus, the headrest 212 is configured to move in the extension direction 228 away from the body 106 after reaching the first end stop position. In some instances, the different occupant may move the headrest 212 in the extension direction 228 away from the body 106 until the headrest 212 reaches the second end stop position (e.g., the housing 226 moves from the coupled position to the uncoupled position at the second end stop position). In the second end stop position, the headrest 212 may stop moving in the extension direction 228 away from the body 106 even as the shaft 224 continues to rotate in the second direction.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An actuator, comprising:
a shaft including a first end and a second end and including a disengagement portion near the first end and an engagement portion near the second end;
a motor coupled to the first end of the shaft and configured to rotate the shaft about a longitudinal axis of the shaft; and
a housing coupled to the shaft and configured to move toward the disengagement portion during rotation of the shaft in a first direction,
wherein the housing has a coupled position, in which the housing is engaged with the engagement portion of the shaft, and an uncoupled position, in which the housing is disengaged from the engagement portion of the shaft and is located adjacent to the disengagement portion of the shaft,
wherein movement of the housing toward the motor is limited in the uncoupled position such that, during rotation of the shaft in a second direction that is opposite the first direction, the housing is configured to engage with the engagement portion of the shaft.

2. The actuator of claim 1, wherein binding of the housing against the motor is limited when in the uncoupled position during rotation of the shaft in the first direction.

3. The actuator of claim 1, wherein the housing remains generally stationary when in the uncoupled position during rotation of the shaft in the first direction.

4. The actuator of claim 1, wherein the housing is configured to resist a force imparted to the housing by the shaft during rotation of the shaft in the first direction when the housing is in the uncoupled position.

5. The actuator of claim 1, wherein the housing includes:
a body, and
a biasing portion located at an end of the body and configured for contact with the motor,
wherein the biasing portion is configured to resist movement of the housing toward the motor when the housing is in the uncoupled position and the biasing portion is in contact with the motor.

6. The actuator of claim 5, wherein the biasing portion is a gasket formed from a resilient material.

7. The actuator of claim 5, wherein the biasing portion is a spring.

8. An actuator, comprising:
a shaft including a first end and a second end and including a disengagement portion near the first end and an engagement portion near the second end;
a motor coupled to the first end of the shaft and configured to rotate the shaft about a longitudinal axis of the shaft;
a housing coupled to the shaft and configured to move toward the disengagement portion during rotation of the shaft in a first direction, the housing having a coupled position, in which the housing is engaged with the engagement portion of the shaft, and an uncoupled position, in which the housing is disengaged from the engagement portion of the shaft and is located adjacent to the disengagement portion of the shaft; and
a biasing portion slidably engaged with the shaft and positioned between the housing and the motor,
wherein the biasing portion is configured to limit movement of the housing toward the motor with the housing in the uncoupled position during rotation of the shaft in the first direction.

9. The actuator of claim 8, wherein the biasing portion is a coil spring.

10. The actuator of claim 8, wherein the biasing portion is a disc spring.

11. The actuator of claim 8, wherein the biasing portion is a wave spring.

12. The actuator of claim 8, wherein the engagement portion of the shaft has threads and the disengagement portion of the shaft is unthreaded,
wherein the housing includes a threaded portion that engages the threads of the engagement portion with the housing in the coupled position, and the threaded portion is disengaged from the threads of the engagement portion with the housing in the uncoupled position.

13. The actuator of claim 12, wherein the threaded portion is configured to remain disengaged from the threads of the engagement portion during rotation of the shaft in the first direction with the housing in the uncoupled position.

14. The actuator of claim 13, wherein the threaded portion is configured to engage the threads of the engagement portion during rotation of the shaft in a second direction that is opposite the first direction to move the housing from the uncoupled position to the coupled position.

15. The actuator of claim 13, wherein binding of the housing against the motor is limited when in the uncoupled position during rotation of the shaft in the first direction.

16. A vehicle, comprising:
a seat; and
a head support, comprising:
a base removably coupled to the seat;
a headrest movably coupled to the base; and
an actuator configured to move the headrest relative to the base,
wherein the actuator has an end stop that limits motion of the headrest relative to the base when the headrest reaches an end stop position, and the actuator is configured to limit binding of the headrest to allow the headrest to move from the end stop position.

17. The vehicle of claim 16, wherein the actuator includes:
a shaft including a first end and a second end and including a disengagement portion near the first end and an engagement portion near the second end,
a motor coupled to the first end of the shaft and configured to rotate the shaft about a longitudinal axis of the shaft, and
a housing coupled to the shaft and to the headrest, the housing configured to move toward the disengagement portion during rotation of the shaft in a first direction,
wherein the housing has a coupled position, in which the housing is engaged with the engagement portion of the shaft, and an uncoupled position, in which the housing is disengaged from the engagement portion of the shaft and is located adjacent to the disengagement portion of the shaft.

18. The vehicle of claim 17, wherein the housing is configured to limit movement of the headrest such that, during rotation of the shaft in a second direction that is opposite the first direction, the housing is configured to engage with the engagement portion of the shaft.

19. The vehicle of claim 17, further comprising:
a biasing portion slidably engaged with the shaft and positioned between the housing and the motor, wherein the biasing portion is configured to limit movement of the headrest toward the seat with the housing in the uncoupled position during rotation of the shaft in the first direction.

20. The vehicle of claim 19, wherein the biasing portion is a spring.

21. The vehicle of claim 19, wherein the biasing portion is a gasket formed from a resilient material.
